(19) United States
(12) Patent Application Publication
(10) Pub. No.: US 2010/0095803 A1
(43) Pub. Date: Apr. 22, 2010

(54) HANDGRIPS AND VEHICLES INCLUDING SAME

(76) Inventors: Daisuke Nagao, Long Beach, CA (US); Kenji Tamura, Redondo Beach, CA (US)

Correspondence Address: ULMER & BERNE, LLP;ATTN: DIANE BELL, 600 VINE STREET, SUITE 2800, CINCINNATI, OH, 45202, US

(21) Appl. No.: 12/254,870

(22) Filed: Oct. 21, 2008

(51) Int. Cl. B62K 21/26; B62K 23/04

(52) U.S. Cl. 74/551.9; 16/421; 16/430; 180/219

(57) ABSTRACT

A handgrip includes a substantially cylindrical body portion extending along a central axis from a first end to a second end. The first end has an opening configured to receive a handle. A grip element is provided in the form of a single, elongated line segment. The grip element extends radially outwardly from the body portion with respect to the central axis and is configured to provide friction in both axial and radial directions with respect to the central axis to facilitate effective gripping of the handgrip by an operator. A vehicle including a handgrip is also disclosed.

### TECHNICAL FIELD

Handgrips are configured to provide friction in both axial and radial directions to facilitate effective gripping thereof by an operator.

### BACKGROUND

Handgrips are conventionally provided on handlebars of saddle-type vehicles such as motorcycles. Many conventional vehicular handgrips are smooth. Smooth handgrips can allow for excessive grip slippage and resultantly may not enable an operator to effectively control an associated vehicle. Other conventional handgrips are provided with a rough surface texture which generally facilitates better gripping, and resultantly enables an operator to better control a vehicle. However, when compared with conventional smooth handgrips, many conventional rough handgrips are not as comfortable for the hands of an operator, are generally not as aesthetically pleasing, and/or can be difficult to clean.

### SUMMARY

In accordance with one embodiment, a handgrip comprises a substantially cylindrical body portion extending along a central axis from a first end to a second end. The first end comprises an opening configured to receive a handle. A grip element is provided in the form of a single, elongated line segment. The grip element extends radially outwardly from the body portion with respect to the central axis and is configured to provide friction in both axial and radial directions with respect to the central axis to facilitate effective gripping of the handgrip by an operator.

In accordance with another embodiment, a vehicle comprises handgrip. The handgrip comprises a body portion and a grip element. The body portion has a substantially cylindrical shape extending along a central axis from a first end to a second end. The first end comprises an opening configured for receiving a handlebar. The grip element is provided in the form of a single, elongated line segment. The grip element extends radially outwardly from the body portion with respect to the central axis. The grip element is configured to provide friction in both axial and radial directions with respect to the central axis to facilitate effective gripping of the handgrip by an operator of the vehicle.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1 is a side elevational view depicting a motorcycle having a handgrip in accordance with one embodiment;

FIG. 2 is a rear view depicting an enlargement of a portion of the left handlebar of the motorcycle of FIG. 1;

FIG. 3 is a rear view depicting an enlargement of a portion of the right handlebar of the motorcycle of FIG. 1;

FIG. 4 is a perspective view depicting the portion of the right handlebar of FIG. 3;

FIG. 5 is a front view depicting an enlargement of a portion of the left handlebar of the motorcycle of FIG. 1; and

FIG. 6 is a plan view depicting the pattern of the handgrip of FIG. 3.

### DETAILED DESCRIPTION

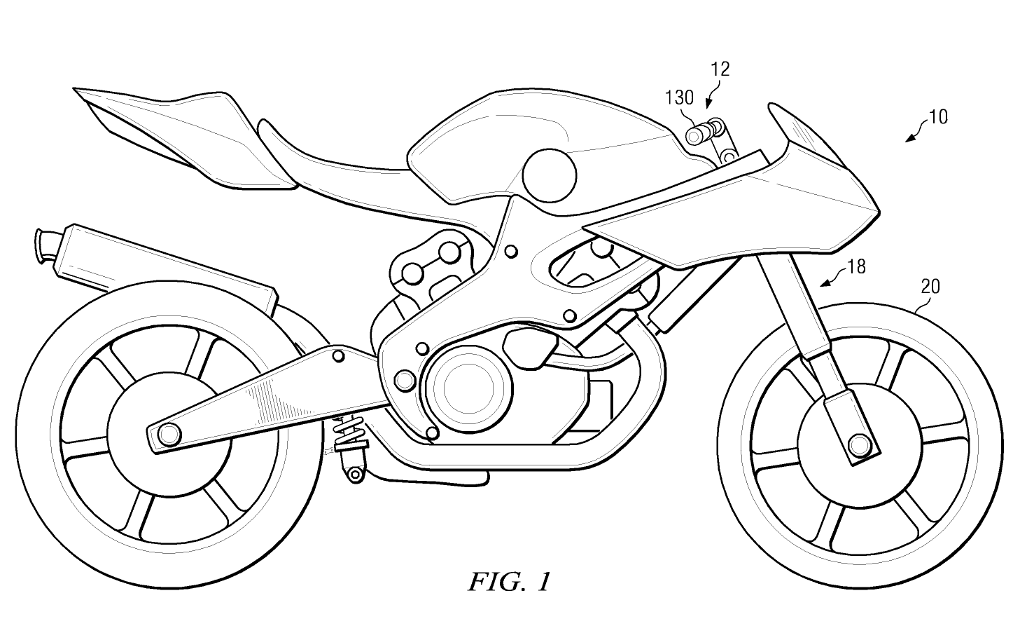

Embodiments are hereinafter described in detail in connection with the views of FIGS. 1-6, wherein like numbers indicate the same or corresponding elements throughout the views. A handgrip in accordance with one embodiment can be provided upon any of a variety of devices such as, for example, a saddle-type vehicle, automobile, truck, van, watercraft, aircraft, recreational vehicle, agricultural equipment, construction equipment, toy, mower, generator, or any of a variety of other vehicles, tools, or machines. A saddle-type vehicle can include, for example, a motorcycle, a scooter, an all terrain vehicle, a personal watercraft, and a snowmobile.

For example, as shown in FIGS. 1-6 a motorcycle 10 can be provided to include a handlebar assembly 12 having a left handlebar 14 and a right handlebar 16. The handlebar assembly 12 can be configured to facilitate steering by an operator of the motorcycle 10 of a front fork 18 and a front wheel 20 of the motorcycle 10. A left handgrip 30 in accordance with one embodiment is shown to be attached to the left handlebar 14, and a right handgrip 130 in accordance with one embodiment is shown to be attached to the right handlebar 16. In an alternative embodiment, left and right handgrips might not be provided separately for attachment to a handlebar assembly, but might rather be integrally formed (e.g., through a common molding or casting process) with respective left and right handlebars.

One or more control devices can be attached to the handlebar assembly 12. For example, brake and/or clutch handles (not shown) might be provided adjacent to one or both of the left and right handgrips 30, 130 such that they might be operable by an operator without requiring removal of the operator's hand from the adjacent handgrip. As another example, switches and/or pushbuttons configured for controlling turn signals, a headlight, marker lamps, an engine starter motor, and/or other devices or accessories present upon the motorcycle might also be attached to the handlebar assembly 12, and may or may not be provided adjacent to the left and/or right handgrips 30, 130.

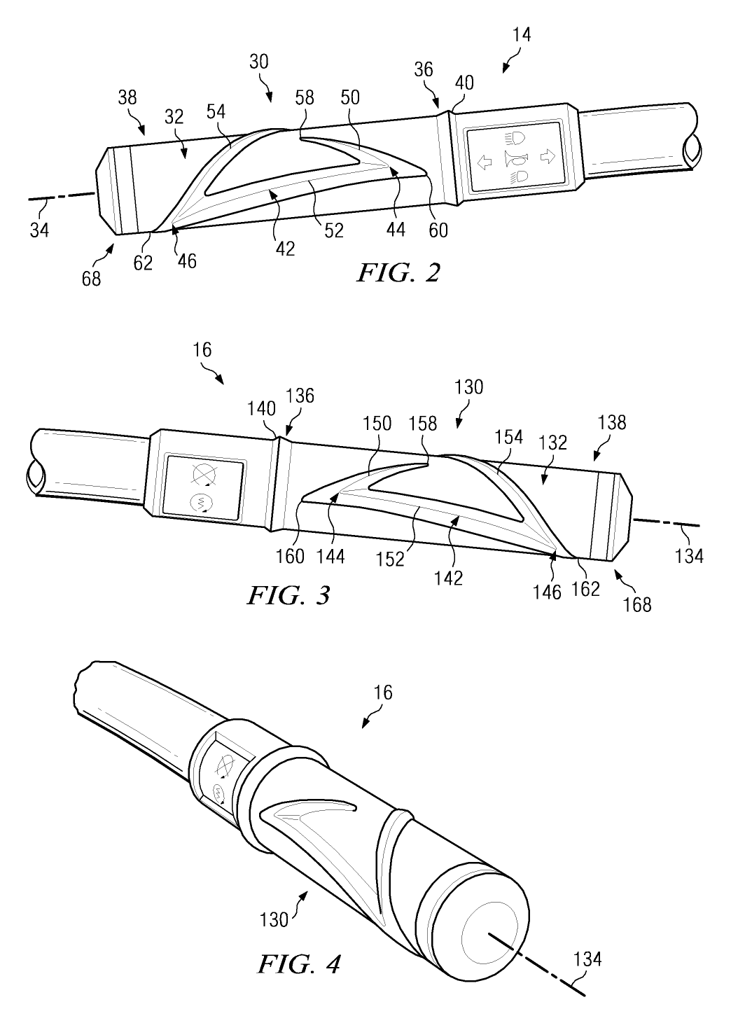

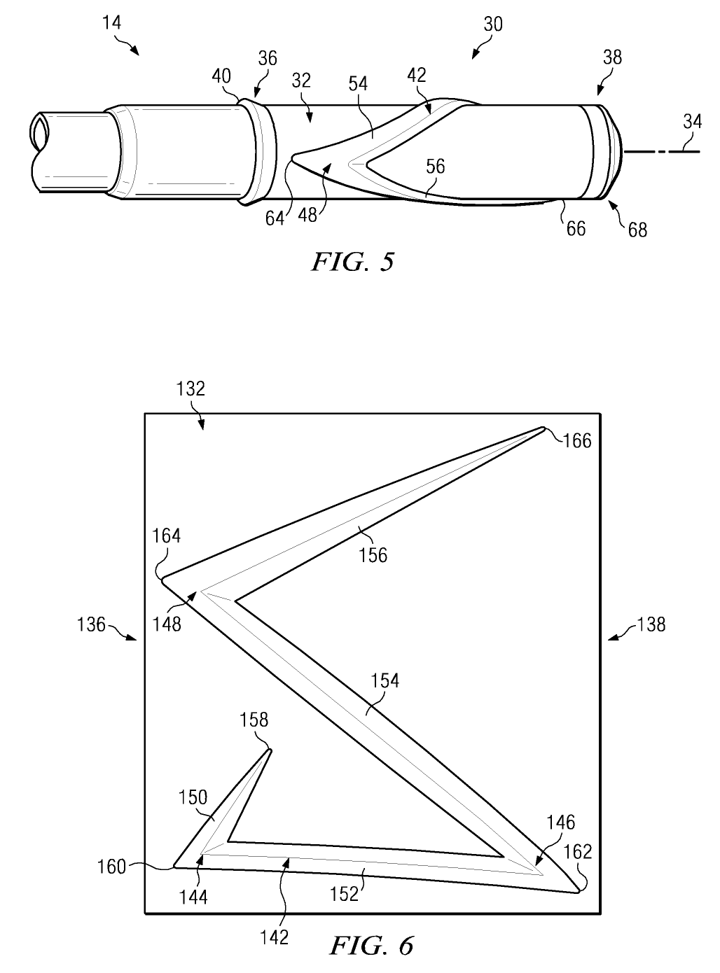

The left handgrip 30 is shown in FIGS. 2 and 5 to comprise a body portion 32 and a grip element 42. The body portion 32 is shown to have a substantially cylindrical shape and to extend along a central axis 34 from a first end 36 to a second end 38. The body portion 32 can be formed from any of a variety of suitable materials such as, for example, metal, plastic, or rubber, and can be formed to have any of a variety of suitable surface textures. In one particular embodiment, the body portion 32 is formed from metal such as stainless steel or aluminum. While the body portion 32 is shown in FIGS. 2 and 5 as having a substantially smooth surface texture (such that the body portion 32 is smooth), it will be appreciated that part or all of the body portion might alternatively be provided with a rough surface texture.

The first end 38 of the body portion 32 can comprise an opening (e.g., at location 40 shown in FIG. 2) into which the left handlebar 14 is inserted to facilitate attachment of the left handgrip 30 to the left handlebar 14. In one embodiment, one or more fasteners, adhesives, and/or other arrangements might be employed to facilitate the attachment of the left handgrip 30 to the left handlebar 14. However, in another embodiment of, the left handgrip 30 can be provided in an interference fit relationship over a portion of the left handlebar 14. The left handgrip 30 may or may not be configured to selectively rotate with respect to the left handlebar 14 such as for use by an operator to control a throttle or other feature of the motorcycle 10.

The second end 38 of the body portion 32 is shown to comprise an end cap 68. The end cap 68 may either be integrally formed with the body portion 32 or may alternatively be formed separately from the body portion 32 but configured for direct attachment to the body portion 32 and/or the left handlebar 14. In one embodiment, the end cap 68 may merely be provided as an ornamental feature. However, in another embodiment, such as when the end cap 68 is configured for direct attachment to the left handlebar 14 (e.g., with a bolt and/or push pin), the end cap 68 might assist in maintaining the left handgrip 30 upon the left handlebar 14.

As shown in FIGS. 2 and 5, the grip element 42 is shown to extend radially outwardly from the body portion 32 with respect to the central axis 34. It will be appreciated that the grip element 42 can be formed from any of a variety of materials which are suitable to facilitate non-slip contact with the hand of an operator. Such materials may include, for example, rubber, plastic, or polymers. In one embodiment, the grip element 42 comprises rubber. In another embodiment, the grip element 42 is knurled such that it provides surface texture to better facilitate non-slip contact with the hand of an operator. In another embodiment, the grip element 42 comprises rubber and the body portion 32 comprises metal. For example, as shown in FIGS. 2 and 5, the rubber can be knurled and the metal can be smooth such that the grip element 42 has a rough surface texture and the body portion 32 has a smooth surface texture. It will be appreciated that a body portion 32 comprising smooth metal can facilitate comfortable gripping of the left handgrip 30 by an operator, an attractive ornamental appearance of the left handgrip 30, and/or relatively easy cleaning of the left handgrip 30.

As seen in FIGS. 2 and 5, the grip element 42 of the left handgrip 30 can have a substantially triangular cross-section extending radially outwardly from the body portion 32, although it will be appreciated that grip elements in accordance with certain alternative embodiments may have other (e.g., semi-circular or rectangular) cross-sections extending radially outwardly from the body portion. It will be appreciated that the radial extension of the grip element 42 from the body portion 32 can relate to the diameter of the body portion 32 in any of a variety of suitable ratios which suitably facilitate gripping of the left handgrip 30 by an operator of the motorcycle 10.

In one embodiment, the grip element 42 is attached to the body portion 32 through passage of portions of the grip element 42 through one or more apertures in the body portion 32. For example, such an arrangement can be achieved through use of an insert-molding process. As another example, a grip element may be inserted into an opening (e.g., at location 40 in FIG. 2) in a body portion, and then pressed outwardly such that a portion of the grip element penetrates an aperture in the body portion to extend radially outwardly from the body portion with respect to its central axis. In another embodiment, the grip element may be adhesively attached to the body portion. In yet another embodiment, the grip element may be provided integrally with the body portion.

The grip element 42 can be provided in the form of a single, elongated line segment. For purposes herein, it will be understood that a line segment includes any line which links two points, regardless of the path taken by the line. As such, a line segment may include one or more bends or turns. For example, the grip element 42 is shown in FIGS. 2 and 5 to include three bends 44, 46 and 48 which distinguish the grip element 42 into four respective grip element portions 50, 52, 54 and 56. More particularly, the first grip element portion 50 is shown to extend diagonally from a first location 58 to a second location 60. The first location 58 is shown to be disposed about midway between the first end 36 of the body portion 32 and the second end 38 of the body portion 32. The second location 60 is shown to be disposed adjacent to the first end 36 of the body portion 32. The first bend 44 is shown to be disposed adjacent to the second location 60.

The second grip element portion 52 is shown to extend diagonally from the second location 60 to a third location 62. The third location 62 is shown to be adjacent to the second end 38 of the body portion 32. The second bend 46 is shown to be disposed adjacent to the third location 62. The third grip element portion 54 is shown to extend diagonally from the third location 62 to a fourth location 64. The fourth location 64 is shown to be adjacent to the first end 36 of the body portion 32. The third bend 48 is shown to be disposed adjacent to the fourth location 64.

The fourth grip element portion 56 is shown to extend diagonally from the fourth location 64 to a fifth location 66. The fifth location 66 is shown to be adjacent to the second end 38 of the body portion 32. In one embodiment, as shown in FIGS. 2 and 5, the grip element 42 can be configured such that each of the first location 58, the second location 60, the third location 62, the fourth location 64, and the fifth location 66 are spaced from one another. In this configuration, the grip element 42 is shown in FIGS. 2 and 5 to extend substantially from the first end 36 of the body portion 32 to the second end 38 of the body portion 32, and is shown to additionally extend substantially about a circumference of the body portion 32. Additionally, in this configuration, the grip element 42 can be adapted to provide friction in both axial and radial directions with respect to the central axis 34 to facilitate effective gripping of the left handgrip 30 by an operator of the motorcycle 10. It will be appreciated that effective gripping of the left handgrip 30 can assist an operator in restraining herself upon the motorcycle 10 and/or adjusting controls adjacent to the left handgrip (e.g., a pushbutton or clutch lever).

In one embodiment, at least some of the grip element portions together generally define an inclined but incomplete triangle. For example, as shown best in FIG. 2, the grip element portions 50, 52, and 54 can together generally define an inclined but incomplete triangle. As shown best in FIGS. 2 and 5, the grip element portions 52, 54 and 56 can also together generally define an inclined “Z” shape. It will be appreciated that the respective grip element portions 50, 52, 54 and 56 can be oriented such that, when an operator's left hand grasps the left handgrip 30, one or more joints in an operator's left hand can correspond with at least one of the respective grip element portions 50, 52, 54 and 56 during normal operation of the motorcycle 10. In one particular embodiment, the respective grip element portions 50, 52, 54 and 56 can be oriented such that, when an operator's left hand grasps the left handgrip 30, each of the respective grip element portions 50, 52, 54 and 56 is positioned such that it substantially corresponds with one or more joints in an operator's left hand during normal operation of the motorcycle 10. Correspondence between the grip element portions 50, 52, 54 and 56 and joints in an operator's left hand can facilitate effective friction between the left handgrip 30 and the left hand of an operator, but without resulting in discomfort to an operator which could otherwise result if the grip element portions were positioned to correspond with non-joint portions of an operator's left hand.

In one embodiment, the grip element is configured such that non-adjacent grip element portions do not contact one another. For example, as shown in FIGS. 2 and 5, the first grip element portion 50 does not directly contact either of the third grip element portion 54 or the fourth grip element portion 56. Also, in this embodiment, the second grip element portion 52 is shown not to directly contact the fourth grip element portion 56, and the third grip element portion 54 is shown not to directly contact the first grip element portion 50. Additionally, in this embodiment, the fourth grip element portion 56 is shown not to directly contact either of the first grip element portion 50 or the second grip element portion 52. However, in an alternative embodiment, the grip element may be configured such that non-adjacent grip element portions do contact one another. In still another embodiment, the grip element may be configured such that even adjacent grip element portions do not contact one another such as when, for example, a space is provided between adjacent grip element portions at a bend.

It will be appreciated that the right handgrip 130 can be configured much as described above with respect to the left handgrip 30. For example, the right handgrip 130 is shown in FIGS. 3-4 and 6 to comprise a body portion 132 and a grip element 142. The body portion 132 is shown to have a substantially cylindrical shape and to extend along a central axis 134 from a first end 136 to a second end 138. The body portion 132 can be formed in any of a variety of configurations and from any of a variety of suitable materials as described above with respect to the left handgrip 30. The first end 138 of the body portion 132 is shown to comprise an opening (e.g., at location 140 in FIG. 3) into which the right handlebar 16 is inserted to facilitate attachment of the right handgrip 130 to the right handlebar 16. Attachment of the right handgrip 130 to the right handlebar 16 can be achieved in any of a variety of manners as described above with respect to the left handgrip 30. The right handgrip 130 may or may not be configured to selectively rotate with respect to the right handlebar 16 such as for use by an operator to control a throttle or other feature of the motorcycle 10. The second end 138 of the body portion 132 is shown to comprise an end cap 168 which can have any of a variety of configurations as described above with respect to the end cap 68.

As shown in FIGS. 3-4 and 6, the grip element 142 is shown to extend radially outwardly from the body portion 132 with respect to the central axis 134. It will be appreciated that the grip element 142 and the body portion 132 can be provided in any of a variety of configurations as described above with respect to the grip element 42. As with the grip element 42 described above, the grip element 142 can be provided in the form of a single, elongated line segment. However, the grip element 142 can, in one embodiment, constitute a mirror of the grip element 42 with respect to an imaginary plane which vertically bisects the motorcycle 10 along the longitudinal axis of the motorcycle 10. This mirrored relationship between the left and right handgrips 30 and 130 can be provided in order to accommodate the physical differences in the left and right hands of an operator.

In particular, the grip element 142 is shown in FIGS. 3-4 and 6 to include three bends 144, 146 and 148 which distinguish the grip element 142 into four respective grip element portions 150, 152, 154 and 156. More particularly, the first grip element portion 150 is shown to extend diagonally from a first location 158 to a second location 160. The first location 158 is shown to be disposed about midway between the first end 136 of the body portion 132 and the second end 138 of the body portion 132. The second location 160 is shown to be disposed adjacent to the first end 136 of the body portion 132. The first bend 144 is shown to be disposed adjacent to the second location 160.

The second grip element portion 152 is shown to extend diagonally from the second location 160 to a third location 162. The third location 162 is shown to be adjacent to the second end 138 of the body portion 132. The second bend 146 is shown to be disposed adjacent to the third location 162. The third grip element portion 154 is shown to extend diagonally from the third location 162 to a fourth location 164. The fourth location 164 is shown to be adjacent to the first end 136 of the body portion 132. The third bend 148 is shown to be disposed adjacent to the fourth location 164.

The fourth grip element portion 156 is shown to extend diagonally from the fourth location 164 to a fifth location 166. The fifth location 166 is shown to be adjacent to the second end 138 of the body portion 132. Each of the first location 158, the second location 160, the third location 162, the fourth location 164, and the fifth location 166 are shown to be spaced from one another. In the configuration of FIGS. 3-4 and 6, the grip element 142 is shown to extend substantially from the first end 136 of the body portion 132 to the second end 138 of the body portion 132, and is additionally shown to extend substantially about a circumference of the body portion 132. Additionally, in this configuration, the grip element 142 can be adapted to provide friction in both axial and radial directions with respect to the central axis 134 to facilitate effective gripping of the right handgrip 130 by an operator of the motorcycle 10. It will be appreciated that effective gripping of the right handgrip 130 can assist an operator in restraining herself upon the motorcycle 10 and/or adjusting controls adjacent to the right handgrip (e.g., a pushbutton or brake lever).

As shown best in FIG. 3, the grip element portions 150, 152, and 154 can together generally define an inclined but incomplete triangle. As shown best in FIGS. 3-4 and 6, the grip element portions 152, 154 and 156 can also together generally define an inclined “S” shape. It will be appreciated that the respective grip element portions 150, 152, 154 and 156 can be oriented such that, when an operator's right hand grasps the right handgrip 130, one or more joints in an operator's right hand can correspond with at least one of the respective grip element portions 150, 152, 154 and 156 during normal operation of the motorcycle 10. In one particular embodiment, the respective grip element portions 150, 152, 154 and 156 can be oriented such that, when an operator's right hand grasps the right handgrip 130, each of the respective grip element portions 150, 152, 154 and 156 is positioned such that it substantially corresponds with one or more joints in an operator's right hand during normal operation of the motorcycle 10. Correspondence between the grip element portions 150, 152, 154 and 156 and joints in an operator's right hand can facilitate effective friction between the right handgrip 130 and the right hand of an operator, but without resulting in discomfort to an operator which could otherwise result if the grip element portions were positioned to correspond with non-joint portions of an operator's right hand. Adjacent and non-adjacent grip element portions of the right handgrip 130 may or may not contact each other as described above with respect to the left handgrip 30.

The foregoing description of embodiments and examples of the invention has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate the principles of the invention and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A handgrip comprising:
a substantially cylindrical body portion extending along a central axis from a first end to a second end, wherein the first end comprises an opening configured to receive a handle;
a grip element in the form of a single, elongated line segment, wherein the grip element extends radially outwardly from the body portion with respect to the central axis and is configured to provide friction in both axial and radial directions with respect to the central axis to facilitate effective gripping of the handgrip by an operator.

2. The handgrip of claim 1 wherein the grip element extends substantially from the first end of the body portion to the second end of the body portion, and additionally extends substantially about a circumference of the body portion.

3. The handgrip of claim 1 wherein the body portion is smooth and the grip element is knurled.

4. The handgrip of claim 3 wherein the body portion comprises metal and the grip element comprises rubber.

5. The handgrip of claim 1 wherein the grip element has a substantially triangular cross-section extending radially outwardly from the body portion.

6. The handgrip of claim 1 wherein the line segment includes bends which distinguish the grip element into respective grip element portions.

7. The handgrip of claim 6 wherein at least some of the grip element portions together generally define an inclined but incomplete triangle.

8. The handgrip of claim 7 wherein at least some of the grip element portions together generally define at least one of an inclined “Z” shape and an inclined “S” shape.

9. The handgrip of claim 6 wherein the grip element comprises a first grip element portion, a second grip element portion, and a third grip element portion, and wherein the first grip element portion extends diagonally from a first location to a second location, the first location is disposed about midway between the first end of the body portion and the second end of the body portion, the second location is disposed adjacent to one of the first end and the second end, the second grip element portion extends diagonally from the second location to a third location adjacent to the other one of the first end and the second end, and the third grip element portion extends diagonally from the third location to a fourth location.

10. The handgrip of claim 9 wherein the fourth location is adjacent to one of the first end and the second end.

11. The handgrip of claim 10 wherein the grip element further comprises a fourth grip element portion extending diagonally from the fourth location to a fifth location.

12. The handgrip of claim 11 wherein the fifth location is adjacent to the other one of the first end and the second end.

13. The handgrip of claim 12 wherein:
the first grip element portion does not directly contact either of the third grip element portion or the fourth grip element portion;
the second grip element portion does not directly contact the fourth grip element portion;
the third grip element portion does not directly contact the first grip element portion; and
the fourth grip element portion does not directly contact either of the first grip element portion or the second grip element portion.

14. The handgrip of claim 13 wherein each of the first location, the second location, the third location, the fourth location, and the fifth location are spaced from one another.

15. The handgrip of claim 1 further comprising an end cap attached to the second end of the body portion.

16. A vehicle comprising:
a handgrip comprising a body portion and a grip element, wherein the body portion has a substantially cylindrical shape extending along a central axis from a first end to a second end, the first end comprises an opening configured for receiving a handlebar, the grip element is in the form of a single, elongated line segment, the grip element extends radially outwardly from the body portion with respects to the central axis, and the grip element is configured to provide friction in both axial and radial directions with respect to the central axis to facilitate effective gripping of the handgrip by an operator of the vehicle.

17. The vehicle of claim 16 wherein the body portion of the handgrip is smooth and the grip element of the handgrip is knurled.

18. The vehicle of claim 16 wherein the line segment includes bends which distinguish the grip element into respective grip element portions, and wherein at least some of the grip element portions together generally define at least one of an inclined but incomplete triangle, an inclined “Z” shape, and an inclined “S” shape.

19. The vehicle of claim 16 wherein the grip element comprises a first grip element portion, a second grip element portion, a third grip element portion, and a fourth grip element portion, and wherein the first grip element portion extends diagonally from a first location to a second location, the first location is disposed about midway between the first end of the body portion and the second end of the body portion, the second location is disposed adjacent to one of the first end and the second end, the second grip element portion extends diagonally from the second location to a third location adjacent to the other one of the first end and the second end, the third grip element portion extends diagonally from the third location to a fourth location adjacent to the one of the first end and the second end, and the fourth grip element portion extends diagonally from the fourth location to a fifth location adjacent to the other one of the first end and the second end.

20. The vehicle of claim 16 comprising a saddle-type vehicle.

21. The vehicle of claim 20 comprising a motorcycle.
